(19) United States
(12) Patent Application Publication
(10) Pub. No.: US 2010/0287337 A1
(43) Pub. Date: Nov. 11, 2010

(54) NONVOLATILE MEMORY DEVICE AND METHOD OF OPERATING THE SAME

(76) Inventors: Beom Ju Shin, Gyeonggi-do (KR); Kyoung Nam Kim, Gyeonggi-do (KR)

Correspondence Address: IP & T Law Firm PLC, 7700 Little River Turnpike, Suite 207, Annandale, VA, 22003, US

(21) Appl. No.: 12/700,400

(22) Filed: Feb. 4, 2010

(30) Foreign Application Priority Data
May 11, 2009 (KR) 10-2009-0040712

(51) Int. Cl. G06F 12/00; G06F 1/04

(52) U.S. Cl. 711/108; 713/500; 713/600; 711/E12.001

(57) ABSTRACT

A nonvolatile memory device has a memory cell array including a memory cell group for storing option information, and a controller configured to wait for a preset period of time after a command for loading the option information has been received before performing an operation of loading the option information.

### CROSS-REFERENCE TO RELATED APPLICATIONS

Priority to Korean patent application number 10-2009-0040712 filed on May 11, 2009, the entire disclosure of which is incorporated by reference herein, is claimed.

### BACKGROUND OF THE INVENTION

Embodiments of the present invention relate to a method of operating a nonvolatile memory device and, more particularly, to a nonvolatile memory device and a method of operating the same, which are capable of stably loading option information when the nonvolatile memory device is first started.

With the recent increasing demand for mobile products, such as camcorders, digital cameras, portable phones, and MPEG-1 Layer3 (MP3) players, attempts are being made to further improve the performance of these mobile products.

The internal option of a nonvolatile memory device for the mobile product is determined to comply with the operating characteristics of a corresponding product such that the nonvolatile memory device can operate according to a corresponding application program.

With the development of new technology, the number of applications for a mobile product is increasing. Accordingly, there is a need for technology for assigning various options to a nonvolatile memory device.

A nonvolatile memory device stores option information using a fuse, etc. However, since the size of the fuse is large and nonvolatile memory devices are highly integrated, the option information is stored using a content addressable memory (hereinafter referred to as a ‘CAM’) cell instead of the fuse.

A nonvolatile memory device storing option information in the CAM cell requires an operation for loading data of the CAM cell during a reset operation and storing the loaded data in an internal register upon being supplied with a voltage from a source of power. The operation for loading data of the CAM cell is performed after a voltage level of the source of power has been stabilized to some extent.

A high current is necessary for the operation of loading data of the CAM cell. Accordingly, a nonvolatile memory device determines whether a power source has been stabilized and performs the operation of loading data of the CAM cell after the power source has been stabilized.

FIG. 1 is a flowchart illustrating a conventional method of loading data of a CAM cell.

Referring to FIG. 1, a nonvolatile memory device begins operating when a power source supplies a voltage Vcc thereto. When a control signal (power select signal (PSL)) to control the supply of voltage from the power source to the nonvolatile memory device shifts to a high level at step S101, an internal reset command is generated even though an external command has not been received at step S103. Data of the CAM cell can be directly read without the reset command.

The controller of the nonvolatile memory device decodes the internal reset command to determine which command the reset command corresponds to at step S105. The controller then determines whether the reset command is the first command generated after the voltage from the power source has been received at step S107.

If, as a result of the determination, the reset command is determined to be the first command, the controller performs a CAM read operation at step S109. However, if, as a result of the determination, the reset command is determined to be other than the first command, the controller performs a pertinent operation, that is, executes a command, at step S111.

As described above, the conventional method has no problem when reading data of the CAM cell because the PSL signal shifts to a high level after a power source is normally turned on and stabilized.

A nonvolatile memory device can use a power-up method of initiating an operation when a power source is slowly turned on (called ‘slow power-on) and reaches a set voltage level.

When the power source reaches a set voltage level, a PSL signal shifts to a high level, but actually the power source is not in a stable state. Accordingly, if data of the CAM cell are read while the power source is not stably supplying a voltage, errors can occur in reading the data.

Data of the CAM cell include various pieces of option information, including parameters for the operation of a nonvolatile memory device. Thus, if erroneous information is read, errors can occur in the operation of the nonvolatile memory device.

### SUMMARY OF THE INVENTION

Embodiments of the present invention relate to a nonvolatile memory device and a method of operating the same, in which option information is loaded after a power source stably supplies a voltage to the nonvolatile memory device.

A nonvolatile memory device according to an embodiment of the present invention includes a memory cell array configured to constitute a memory cell group for storing option information, and a controller configured to wait for a preset period of time after a command for loading the option information has been received and to then perform an operation of loading the option information.

The nonvolatile memory device further includes a clock generator enabled to output a clock signal in response to an enable signal and a counter configured to perform a counting operation in response to the clock signal and to output a control signal upon a counted value reaching a set value as determined by the counting operation. The controller performs the operation of loading the option information in response to the control signal.

The controller recognizes a reset command, first received after a voltage from a power source has been received, as the command for loading the option information.

The controller controls an operation for the corresponding reset command upon a reset command, inputted after the voltage from the power source has been received, being other than a first reset command.

A method of operating a nonvolatile memory device according to another embodiment of the present invention includes providing the nonvolatile memory device having a memory cell array constituting a memory cell group for storing option information, inputting a voltage from a power source to the nonvolatile memory device and inputting a first command for storing the option information in the memory cell group, and delaying an execution of the first command for a preset period of time and, after the preset period of time has passed, loading the option information of the memory cell group according to the first command.

The first command is a reset command first received after the voltage from the power source has been received.

If a second command other than the first command has been received, then the second command is immediately executed.

Delaying the execution of the first command for the preset period of time includes enabling a clock generator of the nonvolatile memory device to generate a clock signal and enabling a counter of the nonvolatile memory device to count the clock signal generated by the clock generator, the counter performing a counting operation up to a set highest count.

The method further includes disabling the clock generator and the counter after the counting operation has been performed up to the highest count.

### BRIEF DESCRIPTION OF THE DRAWINGS

FIG. 1 is a flowchart illustrating a conventional method of loading data of a CAM cell;

FIGS. 2A and 2B are waveform diagrams showing a shift in the control signal according to a method of inputting a voltage from a power source to a nonvolatile memory device according to an embodiment of the present invention;

FIG. 3 is a block diagram of a nonvolatile memory device according to an embodiment of the present invention;

FIG. 4A is a flowchart illustrating an operation of the nonvolatile memory device according to a first embodiment of the present invention;

FIG. 4B is a flowchart illustrating a delay operation of the nonvolatile memory device illustrated in FIG. 4A; and

FIG. 5 is a flowchart illustrating an operation of the nonvolatile memory device according to a second embodiment of the present invention.

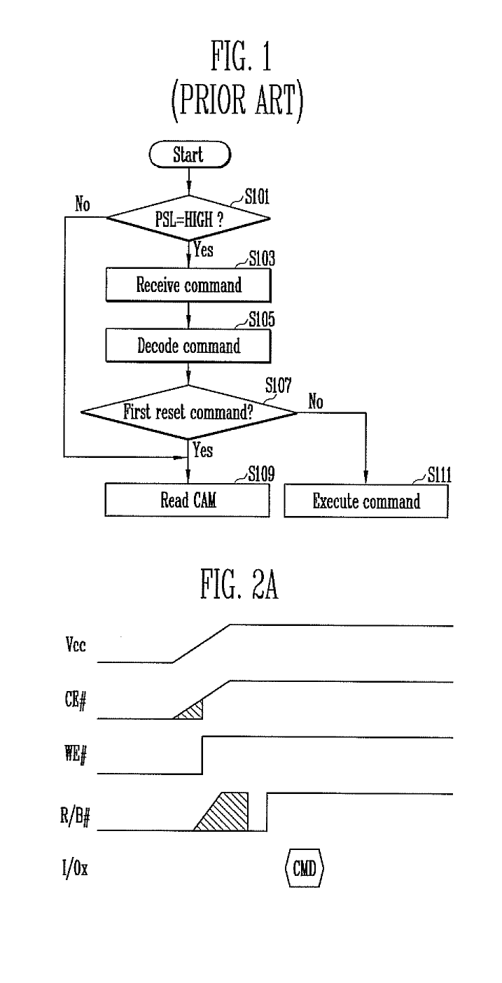

### DESCRIPTION OF THE INVENTION

Hereinafter, embodiments of the present invention are described in detail with reference to the accompanying drawings. The drawing figures are provided to allow those having ordinary skill in the art to understand the scope of the embodiments of the present invention.

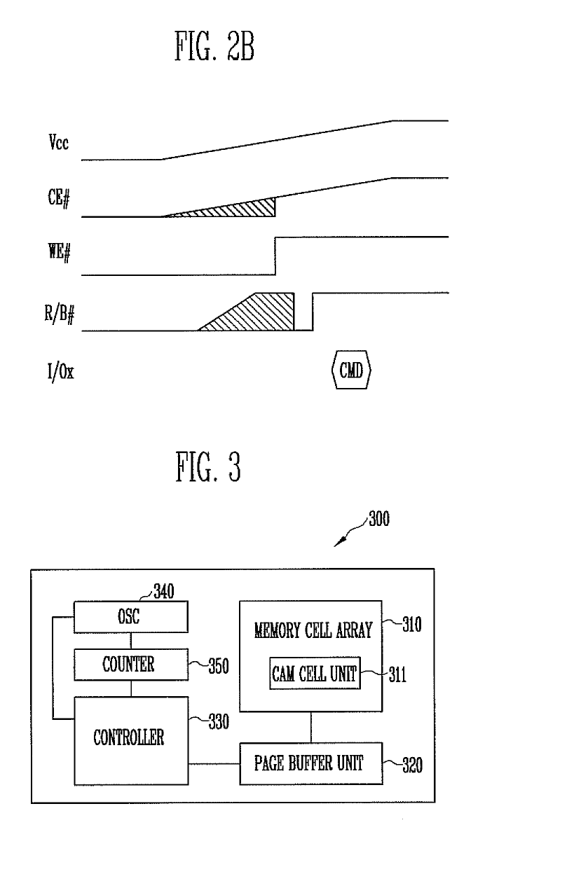

FIGS. 2A and 2B are waveform diagrams showing a shift in the control signal according to a method of inputting a voltage from a power source to a nonvolatile memory device according to an embodiment of the present invention.

FIG. 2A shows control signals when an operation is performed according to a fast power-on method, and FIG. 2B shows control signals when an operation is performed according to a slow power-on method.

The fast power-on method is used to start an operation after a power source has been stabilized. The slow power-on method is used to start an operation when an inputted voltage from a power source reaches a set voltage level, even though the power source has not yet been stabilized.

Referring to FIG. 2A, when a voltage from a power source Vcc has been received, slowly raised, and then stabilized, a chip enable signal CE# shifts to a high level, and a ready busy bar signal R/B# to start an operation shifts to a high level.

Referring to FIG. 2B, in the slow power-on method, the ready busy bar signal R/B# shifts to a high level before the voltage from the power source Vcc is fully stabilized.

As shown in FIGS. 2A and 2B, in the fast power-on operation, a command CMD is inputted after the voltage from the power source Vcc has been stabilized, and in the slow power-on operation, the command CMD is inputted before the voltage from the power source Vcc has been stabilized.

If, as described above, the time when the command is inputted in the fast power-on method and the time when the command is inputted in the slow power-on method differ, problems can occur when reading the data of a CAM cell in which option information is stored. That is, in the slow power-on method, if the command for loading option information is inputted with the voltage from the power source Vcc not being stabilized, the option information is loaded in the state in which the voltage from the power source is not stably supplied. If the option information is loaded when the voltage from the power source is not being stably supplied, the option information may not be normally loaded.

To solve the problem, in an embodiment of the present invention, a method of waiting for a preset period of time before loading option information is used. A circuit for implementing the method is described below.

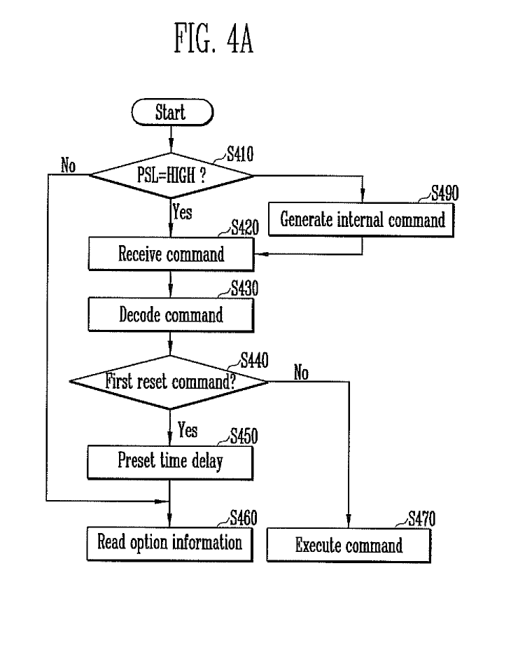

FIG. 3 is a block diagram of a nonvolatile memory device according to an embodiment of this disclosure.

Referring to FIG. 3, the nonvolatile memory device 300 according to the embodiment of the present invention includes a memory cell array 310, a page buffer unit 320, a controller 330, an oscillator (OSC) 340, and a counter 350. For simplicity purposes, the nonvolatile memory device 300 of FIG. 3 includes only portions thereof for describing the embodiments of the present invention.

The memory cell array 310 includes memory cells for storing data. The memory cells are coupled together by bit lines and word lines. Some of the memory cells include a CAM cell unit 311 including CAM cells for storing option information.

The CAM cell unit 311 stores option information, including parameter information for the operations of the nonvolatile memory device 300.

The page buffer unit 320 includes page buffers each coupled to one or more bit lines. The page buffer temporarily stores data to be programmed into a selected memory cell or reads data stored in a selected memory cell and temporarily stores the read data.

The OSC 340 generates and outputs a clock signal. The counter 350 performs a counting operation in response to the clock signal of the OSC 340. The OSC 340 and the counter 350 delay the time when the command is executed. That is, the counter 350 is previously set to the highest count. When the highest count is reached, the counter 350 outputs a control signal indicating that the counting operation has been completed.

The controller 330 can determine whether a set period of time has elapsed based on the control signal of the counter 340.

The controller 330 identifies a first received reset command after a voltage from a power source has been inputted to the nonvolatile memory device 300 and controls an operation of loading the option information stored in the CAM cell unit 311 such that the operation is started. When a command for loading the option information has been received, the controller 330 enables the OSC 340 and the counter 350. When the control signal has been received from the counter 350, the controller 330 controls the operation for loading the option information such that the operation is started.

The process of loading the option information by the nonvolatile memory device 300 is described in detail below.

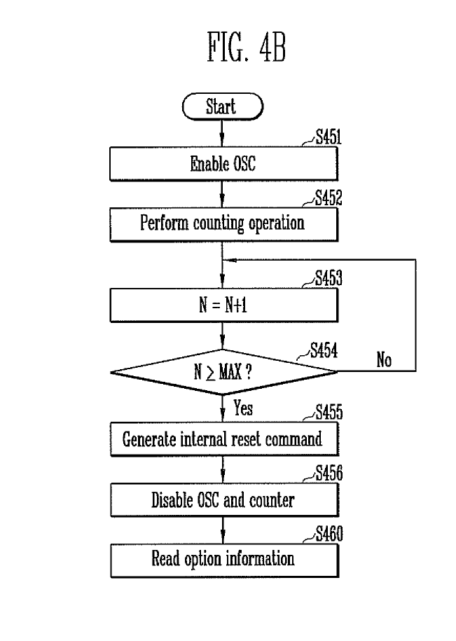

FIG. 4A is a flowchart illustrating an operation of the nonvolatile memory device according to a first embodiment of the present invention.

Referring to FIG. 4A, when a voltage from a power source is inputted to the nonvolatile memory device 300 according to the present embodiment and a PSL signal shifts to a high level at step S410, a ready busy bar signal R/B# shifts to a high level, so that the command for loading the option information can be inputted.

The PSL signal has been previously set in the nonvolatile memory device. The PSL signal has a signal level set when the nonvolatile memory device 300 is first fabricated. If the PSL signal is set to a high level, an external command for loading the option information of a CAM cell has been received. If the PSL signal is set to a low level, a command for loading the option information of a CAM cell has been internally generated within a nonvolatile memory device.

Further, when the PSL signal has not been supplied to the nonvolatile memory device 300, an external command for loading option information has to be received,

Next, if the PSL is set to a high level, an external command for loading the option information of the CAM cell unit 311 is received at step S420. However, if the PSL is set to a low level, a command for loading the option information is internally generated at step S490.

The controller 330 decodes the command at step S430 and determines the operation corresponding to the command based on the decoding result. The controller 330 determines whether the command is a first reset command at step S440.

The nonvolatile memory device 300 performs the operation of loading the option information of the CAM cell unit 311 according to the first reset command.

If, as a result of the determination, the command is determined to be the first reset command, the controller 330 waits for a preset period of time at step S450. After the passage of the preset period of time, the controller 330 performs the operation of reading the option information of the CAM cell unit 311 at step S460.

If, as a result of the determination at step S440, the command is determined not to be the first reset command, the controller 330 controls an operation according to the corresponding command so that the corresponding operation is performed at step S470.

The delay operation during the preset time period (S450) is described in detail below.

FIG. 4B is a flowchart illustrating a delay operation of the nonvolatile memory device illustrated in FIG. 4A.

Referring to FIG. 4B, for delay during the preset time period, the controller 330 first enables the OSC 340 at step S451. The counter 340 starts a counting operation in response to the clock signal of the OSC 340 at step S452.

The counter 350 increases a count N by ‘1’ in response to the clock signal at step S453 and checks whether the count N is equal to or greater than the highest count MAX corresponding to the preset time period at step S454.

If the count check determines that the count N equals the highest count MAX, then the preset time period has elapsed. The counter 350 then outputs the control signal to the controller 330, indicating that the preset time period has elapsed.

The delay operation is performed using the clock signal internally generated by the OSC 340, and so an external clock signal is not needed.

The controller 330 determines that the preset time period has elapsed based on the control signal of the counter 350 and generates an internal reset command at step S455. Further, the controller 330 disables the OSC 340 and the counter 350 in order to reduce unnecessary current consumption after the preset time period has elapsed at step S456.

The controller 330 performs the operation of reading the option information according to the internal reset command at step S460.

Meanwhile, a nonvolatile memory device to which the PSL signal is not supplied does not require the process of checking the PSL signal.

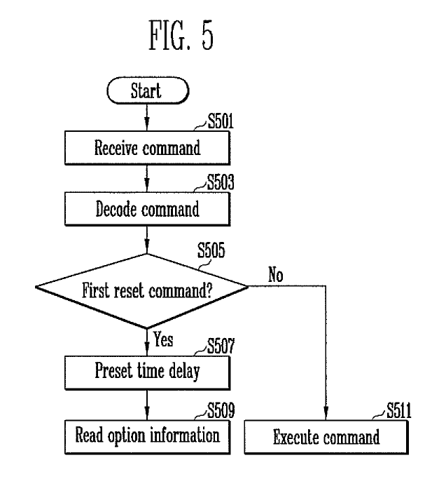

FIG. 5 is a flowchart illustrating an operation of the nonvolatile memory device according to a second embodiment of the present invention.

Referring to FIG. 5, since the PSL signal is not used after the voltage from the power source has been received, a command for loading the option information is immediately received at step S501. Next, the corresponding command is decoded at step S503, and a determination is made as to whether the command is a first reset command at step S505.

If, as a result of the determination, the command is determined to be the first reset command, the controller 330 is delayed for the preset time period at step S507 and the operation of reading the option information of the CAM cell unit 311 is performed at step S509. Such a delay during the preset time period has been described above with reference to FIG. 4B.

If, as a result of the determination at step S505, the command is determined to be the first reset command, the controller 330 controls an operation according to the corresponding command so that the corresponding operation is performed at step S511.

In the first and second embodiments, a reset command first received after a voltage from a power source has been inputted to the nonvolatile memory device 300 is recognized as a command for loading option information. The preset time period, preset before the option information has been loaded, is delayed, and an operation of loading the option information is performed. Accordingly, after a power source has been stabilized in any situation, option information can be loaded.

The method in accordance with the present invention can be applied to both the fast power-on method and the slow power-on method. An operation of loading option information is performed after a power source has been stabilized irrespective of whether a voltage from the power source has been received and the operation is performed using either of the two methods. Accordingly, option information can be loaded more accurately.

As described above, according to the nonvolatile memory device and the method of operating the same in accordance with the present invention, when loading option information after a voltage from a power source has been received, the execution of a command for loading the option information is delayed for a preset period of time even after the command has been inputted. Accordingly, option information can be correctly read because the option information is read after the voltage from the power source, supplied to a nonvolatile memory device, has been stabilized.

What is claimed is:

1. A nonvolatile memory device, comprising:
a memory cell array including a memory cell group for storing option information; and
a controller configured to wait for a preset period of time after a command for loading the option information has been received before performing an operation of loading the option information.

2. The nonvolatile memory device of claim 1, further comprising:
a clock generator for outputting a clock signal in response to an enable signal; and
a counter configured to perform a counting operation in response to the clock signal and to output a control signal upon a counted value reaching a set value as determined by the counting operation,
wherein the controller performs the operation of loading the option information in response to the control signal.

3. The nonvolatile memory device of claim 2, wherein the controller recognizes a reset command, first received after a voltage from a power source has been received, as a command for loading the option information.

4. The nonvolatile memory device of claim 3, wherein, if a reset command inputted after the voltage from the power source has been received is other than a first reset command, then the controller controls an operation for a corresponding reset command.

5. A method of operating a nonvolatile memory device, comprising:
providing the nonvolatile memory device having a memory cell array including a memory cell group for storing option information;
inputting a voltage from a power source to the nonvolatile memory device and inputting a first command for storing the option information in the memory cell group; and
delaying an execution of the first command for a preset time period and, after the preset time period has elapsed, loading the option information of the memory cell group according to the first command.

6. The method of claim 5, wherein the first command is a reset command first received after the voltage from the power source has been received.

7. The method of claim 5, wherein, if a second command other than the first command has been received, then the second command is immediately executed.

8. The method of claim 5, wherein delaying the execution of the first command for the preset time period comprises:
enabling a clock generator of the nonvolatile memory device to generate a clock signal and enabling a counter of the nonvolatile memory device to count the clock signal generated by the clock generator, the counter performing a counting operation up to a set highest count.

9. The method of claim 8, further comprising disabling the clock generator and the counter after the counting operation has been performed up to the highest count.
